(19) United States
(12) Patent Application Publication
(10) Pub. No.: US 2003/0081009 A1
(43) Pub. Date: May 1, 2003

(54) Function shifting apparatus for use with an electronic appliance, such as a video recorder, having an on-screen display and method for using the same

(76) Inventor: Byung-Ryul Seo, Yongin-City (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/270,147

(22) Filed: Oct. 15, 2002

(30) Foreign Application Priority Data
Oct. 29, 2001 (KR) 2001-66849

(51) Int. Cl. G09G 5/00

(52) U.S. Cl. 345/812

(57) ABSTRACT

A function shifting apparatus for an electronic appliance using an onscreen display, and a method for using the same. The function shifting apparatus and method employ a first switch for outputting a cursor moving signal according to the manipulation, and a second switch for outputting a signal for function shifting. A plurality of icons representing pre-set functions of the appliance that are set during initialization of an on condition of the appliance are displayed on the display screen of the appliance. The apparatus and method further employ an indicating unit for displaying and moving the cursor on the display screen according to the signal from the first switch to select one of the icons, and a control unit for switching the state of the function of the appliance represented by the selected icon according to the output signal of the second switch. Accordingly, the icons are displayed on the display screen concurrently with the image already being displayed on the display screen, so that the functions of the electronic appliance can be shifted without having to shift the menu in a rather complicated menu mode and also without requiring a separate external button for function shifting.

This application claims benefit under 35 U.S.C. §119 from Korean Patent Application No. 2001-66849, filed on Oct. 29, 2001, the entire content of which is incorporated herein by reference.

### BACKGROUND OF THE INVENTION

1. Field of the Invention

The present invention generally relates to a function shifting apparatus for use with an electronic appliance, such as a video camcorder or television, and a method for using the same. In particular, the present invention relates to a function shifting apparatus for an electronic appliance, which has an on-screen display (OSD) that can be used for changing functions of the appliance, or for adjusting the control operation of the electronic appliance via a simple key manipulation of icons representing respective functions.

2. Description of the Related Art

Generally, when an operator of an electronic appliance, such as a camera, video camcorder or television, wants to select a desired function, he or she needs to check and adjust the operation or control status of the appliance. For this purpose, conventional appliances typically include an operational panel and a key input portion which enables the operator to control the electronic appliance as desired. That is, the operator inputs a command by manipulating a key input portion, while checking the operation and control status of the appliance on, for example, a display window.

Recently, as the customer's demands for more compact-sized appliances of elegant design increase, there has been increasing requirements for fewer physical buttons on the device. However, an appliance having complicated functions generally requires a great number of buttons for enabling an operator to select the numerous functions that the appliance is capable of performing. This need to increase the functionality of the appliance while also minimizing the number of control buttons not only results in a complex design of the appliance, but also limits the scope of design while also resulting in increased material costs. As a solution to such problems, an onscreen display (OSD) menu having an OSD function has been developed to replace the physical buttons.

FIG. 1 is a flowchart showing an example of an operation of the method for shifting the state of a function of the appliance using a conventional OSD menu, and FIG. 2 is a view showing a display portion displaying the menu mode according to the method for shifting the function using the conventional OSD menu.

As shown in FIGS. 1 and 2, to shift the state of a function of the appliance, the operator manipulates the operational panel and turns the menu mode on in step S10. When the menu mode is turned on, the menu list corresponding to the first directory of the menu is displayed in step S11. In order to shift one or more sub-functions relating to the functions indicated in the menu list, the operator moves a cursor 31 to the upper menu that includes the function he or she wants to shift, and selects a corresponding lower menu, commonly referred to as a “drop down menu”, by manipulating the key input portion in step S12. After step S12, a lower menu is displayed on the screen proximate to where the cursor 31 is positioned. Accordingly, the operator moves the cursor 31 to the desired function in the lower menu list, and can shift that function on or off by manipulating the selection key as desired, as indicated in steps S13, S14 and S15.

As mentioned above, FIG. 2 shows an example of a portion of the display screen where the conventional OSD is displayed. As discussed, the operator shifts the state of a desired function by moving from the menu mode to the lower menu, moving the cursor 31 to the desired function, and then manipulating the key input portion to place that function in an on or off state.

As can be appreciated from the processes described above, if the operator wants to shift the state of one function on or off, he or she has to start from the first step S10 and repeat all of the steps. In order for the operator to shift the state of a function on or off without having to repeat all these complicated steps, the appliance employs an external key input portion 10 as shown in FIG. 3 which can act as a shortcut key to shift a designated function on or off.

Also, in order to shift the function on or off by using the OSD menu displayed on the screen of, for example, a television or a video camcorder displaying photographed pictures, the operator has to have the OSD menu displayed on the screen that he or she is watching. Then, the operator has to go through the complicated process of moving from the menu mode into the lower menu and shifting the function off or on as desired.

Accordingly, the operator has to go through the complicated processes in the middle of shooting or watching pictures even to perform a simple operation such as shifting a desired function on or off. Also, since the operator has to have the menu screen displayed on the screen that he or she has been watching, the initial screen is covered and thus obstructed by the menu screen.

Also, when the menu mode using the OSD is used in the electronic appliance having complicated functions, the operator has to endure the inconvenience of having to go through complicated processes for function selection and manipulation. Moreover, even though the appliance can include external physical buttons to make shifting of a particular function more convenient for the operator, the addition of one or more of such physical buttons makes the appliance more complicated, while also limiting the scope of its design and increasing the material cost for manufacture, thus increasing the overall cost of the appliance.

### SUMMARY OF THE INVENTION

Accordingly, it is an object of the present invention to provide a function shifting apparatus and method for an electronic appliance having an on-screen display apparatus which enables an operator to shift the state of a function of the electronic appliance through a simple process while concurrently being able to watch a display on a display screen that he or she was already watching, and without having to switch to a menu mode as in the conventional technique.

It is another object of the present invention to provide a function shifting apparatus and method for an electronic appliance having an on-screen display apparatus, which enables a user of the appliance to shift a function of the electronic appliance via a simple manipulation of the on-screen display.

These and other objects are substantially accomplished by a function shifting apparatus and method for an electronic appliance having a display unit for displaying a plurality of pre-set functions according to an embodiment of the present invention. The apparatus and method employ an indicating unit for displaying one or more icons and a cursor on a display screen of the appliance. Each of the icons represents a respective function that can be performed by the appliance, as well as the current state of that function. The cursor is used for selecting any of the icons to shift a desired function between off and on states, for example. The apparatus and method further employ a first switch for outputting a signal for moving the cursor on the display screen, a second switch for outputting a signal for turning on or off the function corresponding to an icon selected via the cursor, and a control unit for switching the function represented by the selected icon on or off based on the output signal of the second switch.

The indicating unit displays the on-screen display for the icons and the cursor on the screen being displayed. The first and the second switches can be formed as a dial button, so that a signal for moving the cursor for a predetermined distance is output when the dial button is turned, and a signal for selecting a particular icon is output when the dial button is pushed.

The above objects are also accomplished by a function shifting apparatus and method for an electronic appliance having a display unit for displaying a plurality of pre-set functions according to another embodiment of the present invention. The apparatus and method performs the operations of turning on an on-screen display (OSD) to display a cursor and a plurality of icons representing pre-set functions of the appliance when the display unit is turned on, moving the cursor according to a signal provided by a first switch, and switching the function represented by the icon on which the cursor is placed between on and off states, when a signal for selecting process is input from a second switch.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart showing the operation of a function shifting method using a conventional on-screen display (OSD);

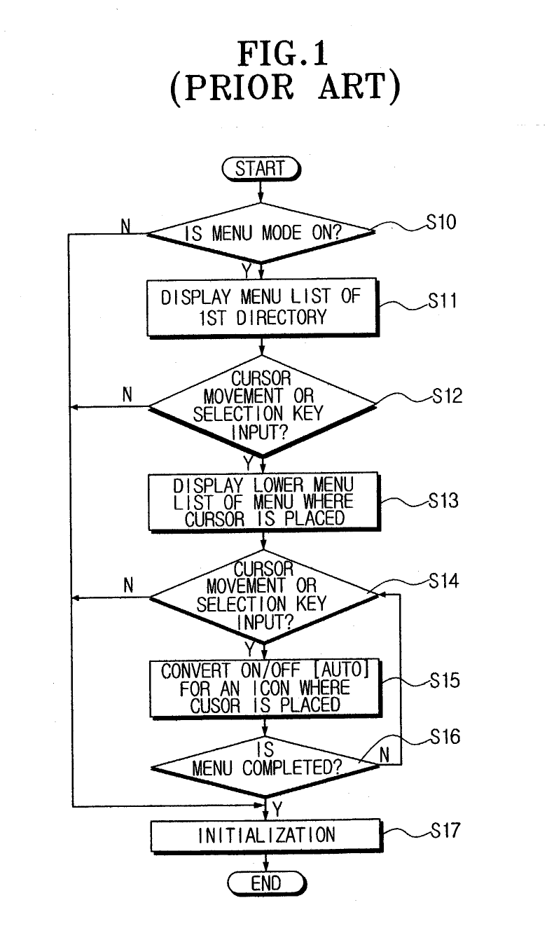

FIG. 2 is a schematic view showing a screen displaying a conventional OSD menu mode;

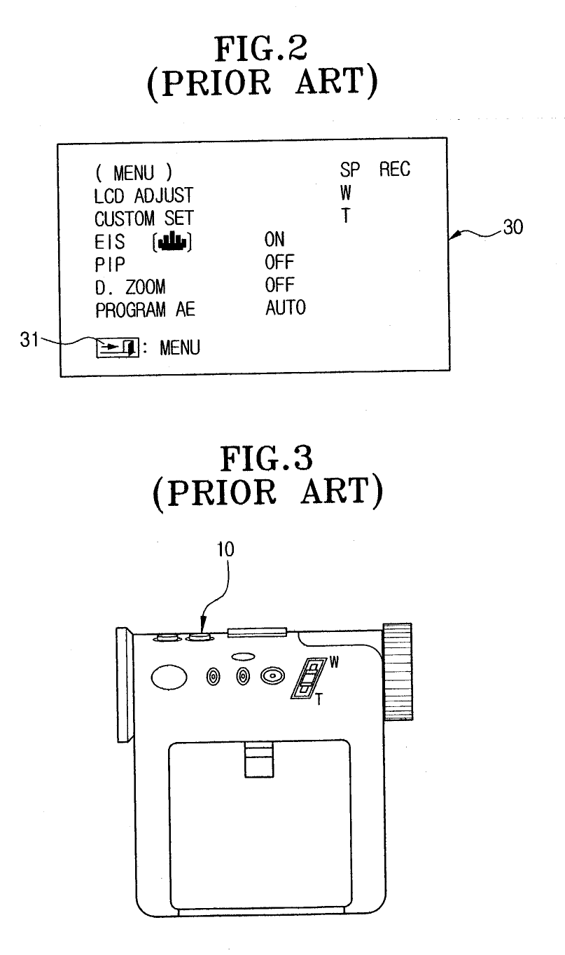

FIG. 3 is a schematic view showing an appliance having a conventional input button for selecting states of a function of the electronic appliance;

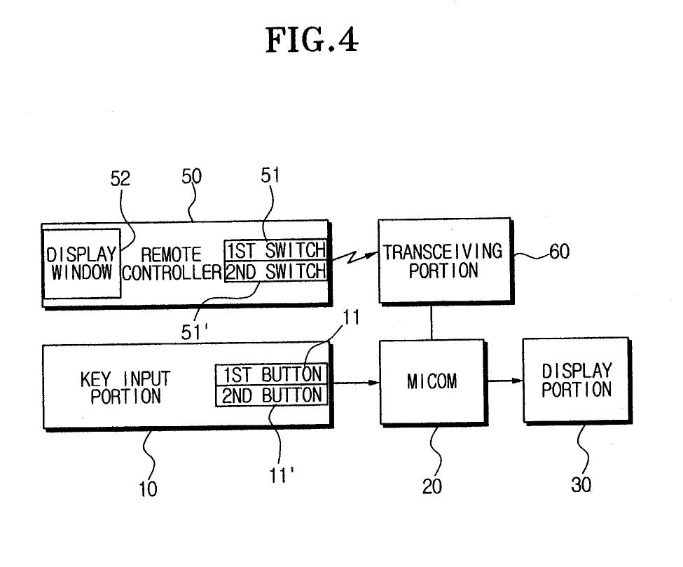

FIG. 4 is a block diagram schematically showing an example of a function shifting apparatus for an electronic appliance according to the present invention;

FIG. 5 is a flowchart showing an example of operations performed by the function shifting apparatus shown in FIG. 4 according to an embodiment of the present invention; and

FIGS. 6, 7A and 7B are views schematically showing examples of items displayed on a screen displayed as a result of the operations shown in FIG. 5 performed by the function shifting apparatus for the electronic appliance according to an embodiment of the present invention.

### DETAILED DESCRIPTION OF THE PREFERRED EMBODIMENTS

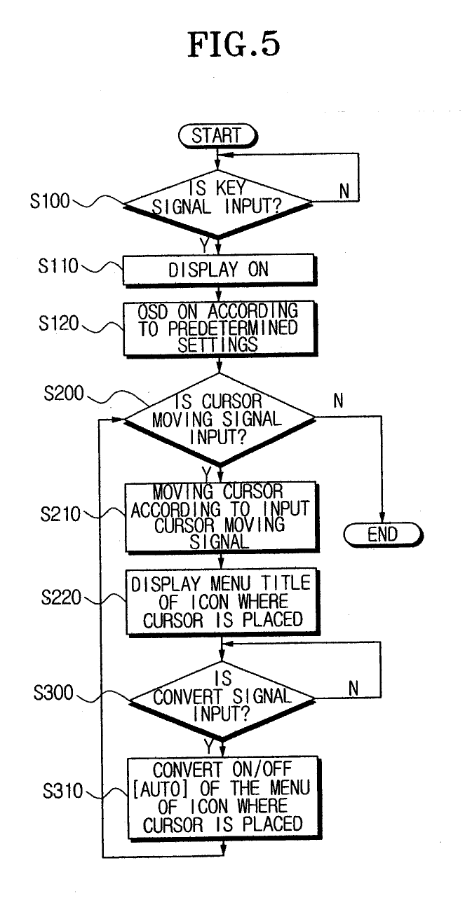

An example of an embodiment of the present invention will now be described with reference to FIGS. 4-7B.

As shown in FIG. 4, the function shifting apparatus according to an embodiment of the present invention includes a key input portion 10 having an operational panel (not shown) mounted in the electronic appliance for function selection or operation adjustment, first and second switches 11 and 11′ in the key input portion 10, a display portion 30 for displaying an on-screen display (OSD) including icons representing functions or status of the appliance, and a control portion 20 for controlling the respective key input and display portions. In addition, a remote controller 50 can be provided to input the operator's command to the electronic appliance via first and second buttons 51 and 51′ which output signals from the remote controller 50. The remote controller 50 further includes a display window 52. The apparatus further includes a transceiving portion 60 for transferring signals between the remote controller 50 and the control portion 20.

In this example, the first and the second switches 11 and 11′ are formed in the key input portion 10 of the operational panel, with the first switch 11 outputting the signal for moving the cursor 31 on the display screen and the second switch 11′ outputting the signal for shifting the status of a function between on and off states. The first and the second switches 11 and 11′ for moving cursor 31 and outputting the function shifting signals, respectively, can be formed separately. Alternatively, the first and the second switches 11 and 11′ can be formed as a dial button, such that when the dial button is turned, the signal of the first switch 11 is output, and when the dial button is pushed, the signal of the second switch 11′ is output.

The display portion 30 for displaying the function or operational status of the electronic appliance can comprise a liquid crystal display (LCD) mounted in the operational panel (not shown). Also, for a television, the display portion 30 can also be formed as a screen on which complex image signals (e.g., a television picture) are displayed. For a video camcorder, the display portion 30 can be formed as a screen on which the photographed or recorded image is displayed. The display portion 30 further displays on the screen one or more icons 32 representing plural functions and operational statuses of the electronic appliance, along with the cursor 31 that can move on the screen according to the signals provided by the first switch 11 or first button 51, and text representing, for example, the date, operational status of the appliance, and so on.

As shown in FIG. 4, the key input portion 10 and the display portion 30 are connected to the control portion 20. The control portion 20 controls the functions of the electronic appliance according to the signals input from the key input portion 10, and provides to the display portion 30 the corresponding OSD signals. If the electronic appliance is provided with a remote controller 50, signals for cursor movement or function selection can also be provided via manipulation of the first and the second buttons 51 and 51′, respectively. Because the remote controller 50 is provided with a display window 52, the operator could monitor the functions being selected and shifted by the manipulation of the first and the second buttons 51 and 51′ on the display window.

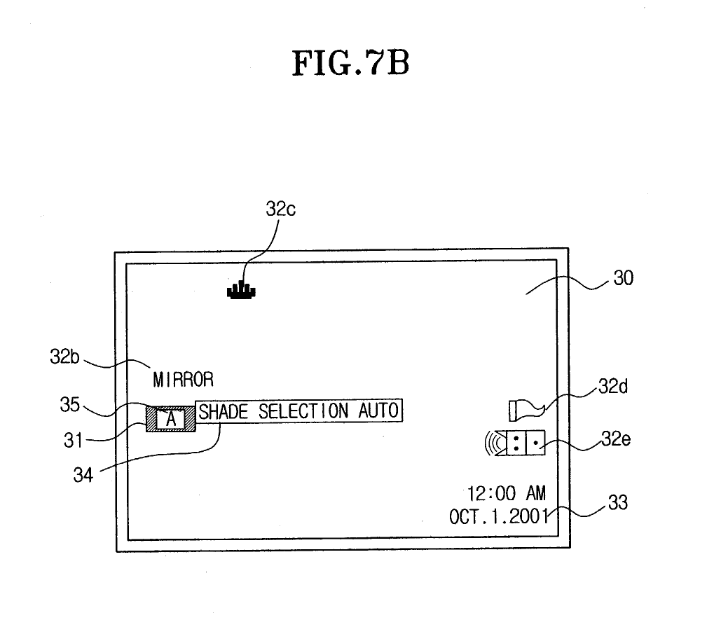

FIG. 6 is a view showing an example of the OSD on the screen of the display portion 30 according to an embodiment of the present invention. As indicated, the screen is displaying the icons 32, the cursor 31, and date/time 33. The icons take respective forms according to the menus, which can be in the form of text like icon 32b, or in symbol form like icons 32a, 32c, 32d, 32e (icons 32a-32e are generally referred to as icons 32). The respective icons 32 are set at predetermined locations on the screen according to the type of the menus, and thus, the icons 32 are controlled to be in an on or off state according to the selection of the functions. During the initialization when the appliance is turned on, the cursor 31 is displayed at a predetermined location on the screen, and moves from its initial position according to the manipulation on the first switch 11. The off-status of a function can be represented as ‘AUTO’, which means the off-status can be selected automatically under the control of the control portion 20. Furthermore, the display portion 30 can display the icons on the display screen in an on-function state when the OSD is turned on, and in an off-function state when the OSD is turned off.

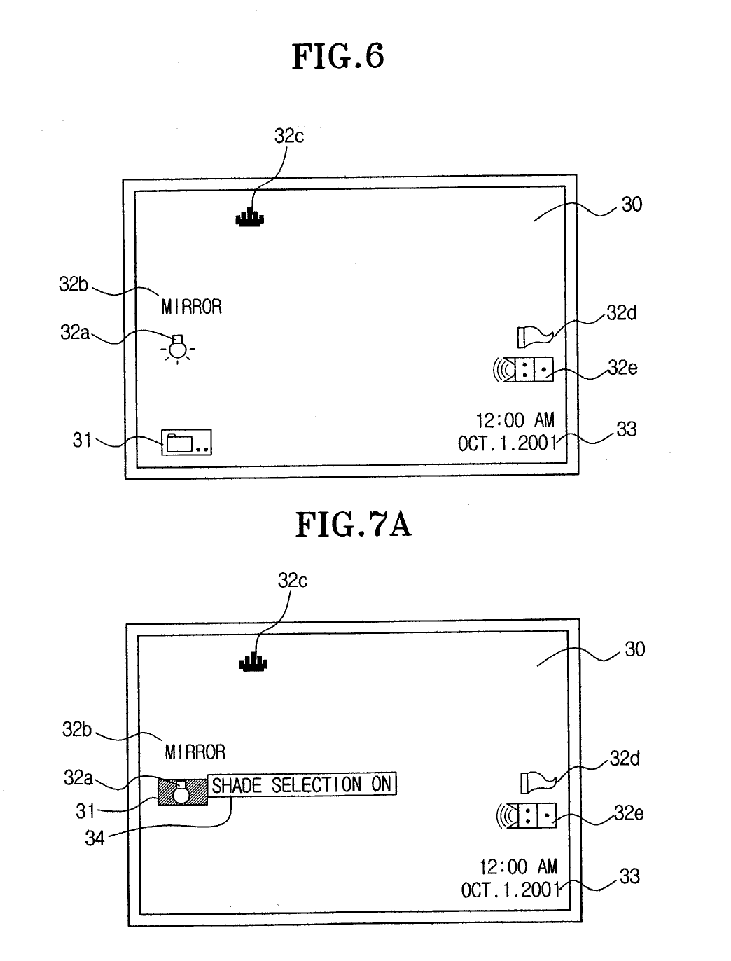

An example of the function shifting performed by the electronic appliance according to an embodiment of the present invention will be described in greater detail below with reference to FIGS. 5-7B.

As the operator manipulates the key input portion 10 and thus inputs a corresponding key signal in step S100, the display portion 30 is turned on in step S110. With the display portion 30 turned on, the OSD is turned on according to the values predetermined for the respective menus, and the icons 32, the cursor 31, and date/time are displayed on the display portion 30 in step S120. Then, as the first switch 11 is manipulated, the signal for cursor movement is input in step S200, and the control portion 20 moves the cursor 31 according to the input signals in step S210. When the cursor 31 is placed on or proximate to an icon 32, an icon 32 in an on-state can be represented in a reversed image, while an icon 32 in an off-state can either flicker or be represented in a light shade. The titles of the menus represented by the icons 32 can be indicated by a tip-box 34, which can be displayed during step S220. Hence, the title of the menu represented by the icon, and the on or off setting is thus indicated by the state in which the relevant icon 32 is displayed. When a signal for function shifting is input in step S300 when the cursor 31 is placed on a certain icon 32, the function of the appliance represented by that particular icon 32 is switched on or off as desired in step S310.

FIGS. 6, 7A and 7B are views showing an example of the OSD being displayed on a screen of a video camcorder according to an embodiment of the present invention.

The operator of the camcorder repeatedly checks the object image displayed on the screen, during shooting. In the camcorder employing an embodiment of the present invention as discussed above, the icons 32 representing the set functions and the cursor 31 are displayable on the screen. Also, in this example, the icons 32 and the cursor 31 are displayable at the corner of the screen, so that they do not cover the original screen. In FIG. 6, icon 32a represents a shade selection function, icon 32b represents a special effect (DSE) function, icon 32c represents a hand-tremor compensation (EIS) function, and icon 32d represents a wind sound removal function, all of which being in an on-state. During initialization, the cursor 31 is placed at a side of the screen. Also, if the date/time 33 are pre-set, the date/time 33 is also displayed on the screen.

In this example, the shade selection 32a can be converted to an automatic state by manipulating the first switch 11 and thus moving the cursor 31 to the shade selection icon 32a. The used can then manipulate the second switch 11′ to shift the state of the shade selection function as desired. During this process, the operator can still check the images being shot and does not have to initiate an OSD display as in the conventional apparatus.

FIGS. 7A and 7B are views showing an example of the process of converting the shade selection from an on state to an automatic state. As shown in FIGS. 7A and 7B, as the operator manipulates the first switch 11, the signal for cursor movement is input into the control portion 20. The control portion 20 accordingly moves the cursor 31 as shown in FIG. 7A. When the cursor 31 is placed on icon 32a, the shade selection icon 32a is represented in a reversed image, and the menu title of the shade selection icon 32a, that is, the “shade selection” and the state of the pre-set function (i.e., ‘ON’), are displayed in a tip-box 34.

Accordingly, when the function shifting signal is input into the control portion 20 by manipulating the second switch 11′ with the cursor 31 being placed on the shade selection icon 32a, the shade selection menu is converted from the ON-state into the AUTO-state, and accordingly, the icon 32a is displayed on the screen as a new icon, which is the AUTO-icon 35. The tip-box 34 also indicates ‘AUTO’ instead of ‘ON’.

As can be appreciated from the above description of an embodiment of present invention, the state of the function settings of the electronic appliance are displayed in the form of icons 32 while the originally-displayed images continue to be displayed. Accordingly, the operator can shift the on/off function of the electronic appliance by simply moving the cursor 31 to a desired icon 32 and performing a simple manipulation.

Also, in order to avoid the situation that the display of icons 32 covers the originally-displayed image, the icons are arranged at the corner of the screen. However, the icons 32 can be displayed at any desired location as deemed appropriate by the manufacturer of the appliance.

According to the disclosed embodiments of the present invention, the operator does not have to repeat the complicated process of entering into the OSD menu mode and finding a corresponding directory to shift the function of the electronic appliance. As the icons representing the respective functions are displayed together with the currently-displayed screen, the operator can easily set a desired function by moving the cursor 31 among the icons.

Although the preferred embodiments of the present invention have been disclosed for illustrative purposes, those skilled in the art will appreciate that various modifications, additions and substitutions can be made without departing from the scope and spirit of the invention as disclosed in the accompanying claims.

What is claimed is:

1. A function shifting apparatus for an electronic appliance having a display screen, the function shifting apparatus comprising:
an indicating unit for displaying a cursor and icon set including at least one icon on the display screen, each said icon representing a respective current functional state of the appliance, and the cursor being adapted to select a said icon;
a switch apparatus, adapted to output a first signal for moving the cursor and a second signal for switching a functional state of a function of the appliance represented by the icon selected by the cursor; and
a control unit, adapted to switch the functional state of the function of the appliance represented by the icon which the cursor selected according to the second output signal.

2. The function shifting apparatus of claim 1, wherein the indicating unit is adapted to display the icon set on the display screen in an on-function state when an on-screen display (OSD) is turned on, and is adapted to display the icon set in an off-function state when the OSD is turned off.

3. The function shifting apparatus of claim 1, wherein the indicating unit is adapted to display the selected icon on the display screen in a flickering condition when the cursor is placed on the selected icon when the selected icon is in an off-function state indicating that its represented function of the appliance is in an off state.

4. The function shifting apparatus of claim 1, wherein the indicating unit is adapted to display on the display screen for a predetermined time a title and an indication of an on/off setting pertaining to the icon on which the cursor is placed.

5. The function shifting apparatus of claim 1, wherein the indicating unit is adapted to display the icon set and the cursor concurrently with an image already being displayed on the display screen.

6. The function shifting apparatus of claim 1, wherein the switch apparatus is formed as a dial button, such that the first signal is output when the dial button is turned, and the second signal is output when the dial button is pushed.

7. The function shifting apparatus of claim 1, wherein the switch apparatus comprising:
a first switch, adapted to output the first signal; and
a second switch, adapted to output the second signal.

8. The function shifting apparatus of claim 1, wherein:
the switch apparatus is disposed on the appliance.

9. The function shifting apparatus of claim 1, wherein:
the switching apparatus is configured as a remote control unit adapted for use with the appliance.

10. The function shifting apparatus of claim 1, wherein:
the control unit is adapted to switch the functional state between an on condition and one of an off condition or an automatic condition according to the second output signal.

11. A method for shifting states of at least one function of an electronic appliance having a display screen, the method comprising:
displaying a cursor and an icon set including at least one icon on the display screen, each said icon representing a respective current functional state of the appliance, and the cursor being adapted to select a said icon;
moving the cursor to a location on the display screen at or proximate to a location at which a said icon is displayed to select said icon; and
switching the functional state of the function of the appliance represented by the icon which the cursor selected.

12. The method of claim 11, wherein the displaying step is adapted to display the icon set on the display screen in an on-function state when an on-screen display (OSD) is turned on, and is adapted to display the icon set in an off-function state when the OSD is turned off.

13. The method of claim 11, wherein the displaying step is adapted to display the selected icon on the display screen in a flickering condition when the cursor is placed on or proximate to the selected icon when the selected icon is in an offfunction state indicating that its represented function of the appliance is in an off state.

14. The method of claim 11, wherein the displaying step is adapted to display on the display screen for a predetermined time a title and an indication of an on/off setting pertaining to the icon which the cursor is placed proximate to or on.

15. The method of claim 11, wherein the displaying step is adapted to display the icon set and the cursor concurrently with an image already being displayed on the display screen.

16. The method of claim 11, wherein the moving and switching steps are performed by a dial button, such that the moving step is performed when the dial button is turned, and the switching step is performed when the dial button is pushed.

17. The method of claim 11, wherein:
the moving step is performed by a first switch; and
the selecting step is performed by a second switch.

18. The method of claim 11, wherein:
the moving and selecting steps are performed by a switch apparatus disposed on the appliance.

19. The method of claim 11, wherein:
the moving and switching steps are performed by a switching apparatus that is configured as a remote control unit adapted for use with the appliance.

20. The method of claim 11, wherein:
the switching step is adapted to switch the functional state between an on condition and one of an off condition or an automatic condition according to the second output signal.
